(19) United States
(12) Patent Application Publication
(10) Pub. No.: US 2014/0171168 A1
(43) Pub. Date: Jun. 19, 2014

(54) SYSTEM AND METHOD FOR DISTRIBUTED SOLITAIRE GAMING

(71) Applicants: Louis Richard Keilin, Woody Creek, CO (US); Jordan Gerberg, Aspen, CO (US)

(72) Inventors: Louis Richard Keilin, Woody Creek, CO (US); Jordan Gerberg, Aspen, CO (US)

(21) Appl. No.: 13/713,992

(22) Filed: Dec. 13, 2012

(51) Int. Cl. G07F 17/32

(52) U.S. Cl. CPC G07F 17/3225; G07F 17/3293
USPC 463/11; 463/42

(57) ABSTRACT

A system and method for distributed solitaire gaming. Selections are received from multiple users to participate in a shared game of solitaire. Wagering information for the shared game is received from the multiple users. The shared game is synchronized between the multiple users for playing the shared game against one another. The results of the shared game are distributed to the multiple users.

### BACKGROUND

Solitaire is any game which may be played by one self or with other individuals. There are many ways of playing solitaire or patience as it is referred to in some countries, most utilize playing cards, tiles, pegs, or stones with distinct markings to play the game. Although versions of solitaire may be played electronically, such as the Klondike variant of solitaire that may be played on the Windows operating system under the title “solitaire”, the systems and methods for playing solitaire alone or against other players have not kept pace with technology. As a result, many players have not had a chance to fully challenge themselves against others and the game of solitaire has not grown in popularity or been introduced to potential players in the younger generations.

### SUMMARY

One embodiment provides a system and method for distributed solitaire gaming. Selections may be received from multiple users to participate in a shared game of solitaire. Wagering information for the shared game may be received from the multiple users. The shared game may be synchronized between the multiple users for playing the shared game against one another. The results of the shared game may be distributed to the multiple users.

Another embodiment provides a server including a processor and memory configured to implement the distributed solitaire gaming method. The server may also include specialized hardware, chipset, programmable gates, or logic for implementing the distributed solitaire game.

Yet another embodiment provides a system for distributed solitaire gaming. The system may include a server configured to receive selections from multiple users to participate in a shared game of solitaire, receive wagering information for the shared game from the multiple users, synchronize the shared game between the multiple users for playing the shared game against one another, and distribute results of the shared game to the multiple users. The system may further include a database in communication with the server. The database may be configured to store the selection, wagering information, and results.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a gaming system in accordance with an illustrative embodiment;

FIG. 2 is a block diagram of a gaming system in accordance with an illustrative embodiment;

FIG. 3 is a flowchart of a process for distributed solitaire gaming in accordance with an illustrative embodiment;

FIG. 4 is a flowchart of a process for wagering on distributed solitaire gaming in accordance with an illustrative embodiment; and

FIG. 5 is a pictorial representation of a user interface for distributed solitaire gaming in accordance with an illustrative embodiment.

### DETAILED DESCRIPTION OF THE DRAWINGS

The illustrative embodiments provide a system, method, and devices for performing distributed solitaire gaming. The game of solitaire whether played with playing cards, or electronically includes various formats, variations, or iterations each of which may be implemented by the illustrative embodiments. The illustrative embodiments may be utilized for single player or multi-player game formats and may allow for wagering or playing for points, rankings, or other non-monetary incentives as well. The users, individuals, computers, participants, people, or logic, participating in a solitaire game may be referred to as users or players.

The illustrative embodiments provide an expanded approach to playing the game against a number of users, synchronizing the game playing process, and wagering on the game. The distributed solitaire gaming system may utilize any number of networks to coordinate, manage, and synchronize game play. For example, the distributed solitaire gaming system may include one or more media networks, such as a television, cable, telephone, data, wireless, or IPTV network for visually representing the game as played (e.g. distributed playing cards, number of users, wagers, etc.) and coordinating actions and activities of the game with the users. The distributed solitaire game may be played utilizing a dedicated channel (e.g. television, interne, etc) or program.

The distributed solitaire gaming system and method may be expanded to allow any number of users at varying levels of proficiency to participate in the game. A user may play for free, points, or based on a wager buying buy the player a position in a multi-player game with the points or wagers being distributed entirely to the winner(s), or proportionally based on the final score.

As previously mentioned, the game may be distributed utilizing any number of media networks, data networks, mobile networks, and other available communications and computing networks, systems, and platforms. For example, hundreds of users may participate in a single game by accessing their electronic device and one or more of the described networks. The users may utilize electronic devices, such as desktop computers, laptop computers, cell phones, smart phones, tablet computers, wireless enabled devices (e.g., mp3 players, e-books, etc.), and other computing or communications devices to participate in the distributed game.

The distributed solitaire gaming system may allow users of different skill levels to participate in games at their desired level, skill, and stakes that are acceptable to them. The distributed solitaire gaming system may allow a user to play for free, points, ranking, prestige, or money. For example, the users may be enabled to wager on the game before or during the game. The distributed solitaire game may be implemented for any number of locations or facilities. For example, users participating utilizing a gaming machine in a casino may play against users utilizing a tablet device at home.

In one embodiment, the users may wager on a solitaire game in multiples of ten regardless of whether the multiples are cents, dimes, dollars, tens of dollars, hundreds of dollars, or so forth. The results of the game, including one or more of point totals, game statistics, number of participating users, playback, and monetary or point winnings, maybe distributed to the participating users through one or more of the associated networks. The gaming instructions, game playback, and results may be distributed in real-time, or discreet messages depending on the preferences of the user. For example, results may be distributed utilizing a screen presented on a graphical user interface, text message, e-mail message, or so forth.

In one embodiment, the users may play against an expert or professional playing the game. The identical card set-up and initial parameters may be utilized by each user. The users may then compete against one another and the professional player to determine who plays the best game of solitaire. The user that scores the most points at the end of the game wins the game and any points, credits, or money associated with the game. In the event of a tie between users, the winnings are equally distributed between the users that tied. The distributed solitaire gaming system may allow the game to be played in multiple formats, such as a single deck hand and multiple deck hands. The illustrative embodiments of the distributed solitaire gaming system provide a system, method, and devices for enjoying and participating in a game of solitaire.

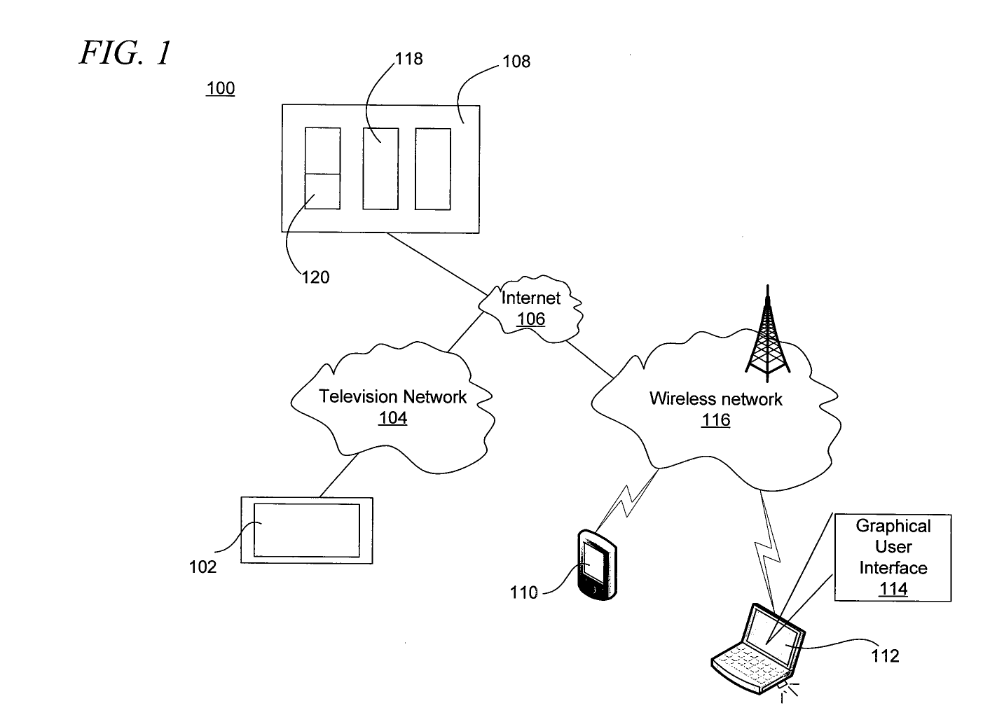

FIG. 1 is a pictorial representation of a gaming system 100 in accordance with an illustrative embodiment. The gaming system 100 may include any number of devices, systems, and equipment. In one embodiment, the gaming system 100 may include a television 102, a television network 104, internet 106, a game management system 108, a wireless device 110, a laptop 112 displaying a graphical user interface 114, and a wireless network 116. The game management system 108 may further include a server 118 and a database 120.

In one embodiment, a user may access the television 102, wireless device 110, or laptop 112 to play the distributed solitaire game. However, the user may utilize any number of electronic devices suitable for communication with any of the networks of the gaming system 100. In other embodiments, the distributed solitaire game may be played by groups of users communicating directly utilizing a wired connections or wirelessly through a local wireless network, Bluetooth, infrared, or other direct communications between devices.

In one embodiment, the electronic devices of the gaming system 100 may include a wireless app, program, script, browser, operating system, kernel, set of instructions, or other software interface for participating in and playing the distributed solitaire game. Dedicated hardware, digital logic, or firmware may also be utilized to implement the illustrative embodiments. For example, a hand held wireless device may be configured for playing the distributed solitaire game with multiple other devices through a direct or indirect (network) connection.

In another embodiment, the electronic devices, such as the television 102, wireless device 110, and laptop 112 may access the distributed solitaire game through a web browser, website or media interface communicating with or hosted by the server 118. A server client relationship may be established for performing the distributed gaming.

In one embodiment, the communications within the gaming system 100 may include security or privacy protection, such as encryption, keys, virtual private networks or tunnels, user names, and passwords, for securing communications within the gaming system 100.

In one embodiment, the user may both play and view the distributed solitaire game through the television 102. For example, the user may utilize a remote control, gaming console and controllers, or wireless device, such as a smart phone, to interface with the television 102 to play the distributed solitaire game. As a result, the user may both initiate and play the distributed solitaire game through the television 102.

The television network 104 represents one or more media networks that may be accessed by the user. The television network 104 may represent a cable, dsl, high speed wireless (e.g., WiMAX, Wi-Fi, etc.), IPTV, fiber optic, or other media network. The user and the associated electronic device may also connect directly or indirectly to the internet 106.

In another embodiment, the user may utilize the wireless device 110 or the laptop 112 to play the distributed solitaire game through the wireless network 116. The user may access the graphical user interface 114 to receive game play parameters, information, preferences, and settings. For example, the graphical user interface 114 may display the virtual playing cards that are displayed to the user for playing a particular game or hand. The graphical user interface 114 may display any number of icons, buttons, tabs, hyperlinks, dropdown menus, interfaces, or selection components for playing in and participating in the game. The randomly selected playing information, such as the distributed playing cards and wagers input, may be distributed in a file or script to initiate the game play.

The wireless network 116 may represent any number of cellular (e.g., CDMA, GSM, Wi-Fi, Wymax, 3G, 4G, GSMR, etc.) or other networks for performing wireless communications. The wireless network 116 allows participating users to move freely and participate from any number of desired locations at the user's convenience.

In one embodiment, the game management system 108 includes the server 118 and the database 120. The server 118 is configured to communicate the electronic information necessary to perform the distributed solitary game. The server 118 may further communicate with the database 122 to store user preferences, game settings, scoring totals, rankings, and other information necessary to play the distributed solitaire game. The database 120 may store information that allows the user accessing any of the electronic devices of the gaming system 102 to repeatedly play distributed solitaire games according to their previously entered preferences and information. For example, the database 120 may store user profiles that may indicate a name, address, skill level, communications preferences, default settings (e.g. wagers, preferred group, location, etc), username, password, link bank accounts, credit cards, electronic wallet, or other information or settings established by the user.

In another embodiment, the game management system 108 may represent a cloud-based system for playing the distributed solitaire game. The game management system 108 and the server 118 may be accessed by any number of users simultaneously to play the distributed solitaire game. In one embodiment, the game management system 108 may synchronize playing of the distributed solitaire game for a number of users so that they may compete or otherwise play against one another in real-time or in coordinated games.

In one embodiment, the functionality and components of the gaming system 100 may be integrated with social networks and mobile platforms. For example, a Facebook app may allow the user to invite and play with friends. As a result, a user may play against his or her friends in games of the distributed solitaire game. In addition, results of the one or more games may be automatically posted as links, replies, posts, or so forth for selected contacts (e.g. friends, family, individuals, groups, etc).

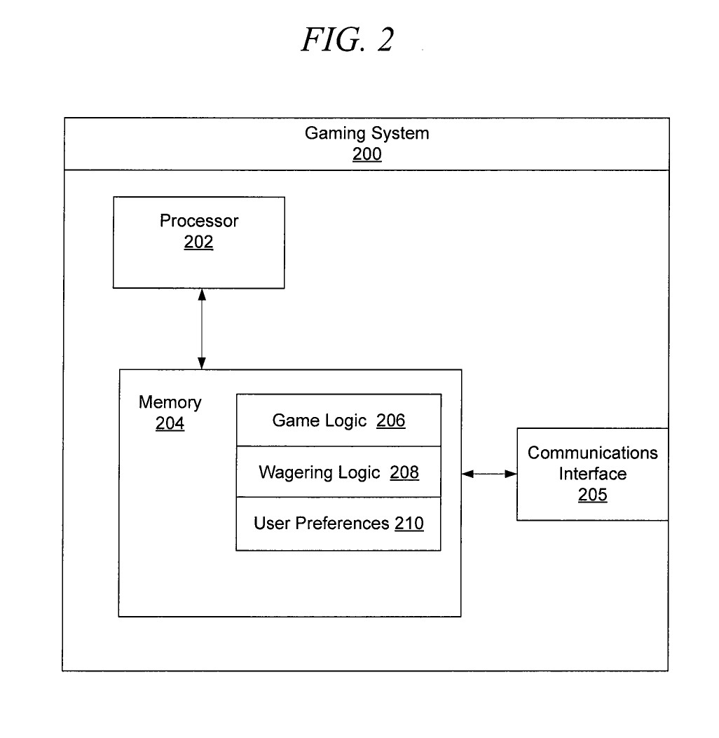

FIG. 2 is a block diagram of a gaming system 200 in accordance with an illustrative embodiment. In one embodiment, the gaming system 200 is a device configured to implement the distributed solitaire game. The gaming system 200 may represent any number of devices, such as servers, intelligent network devices, personal computers, laptops, wireless devices, or other electronic devices. The gaming system 200 may include any number of hardware, software, and firmware components that are not specifically described herein, including displays, processing components, additional memories, busses, interfaces, adapters, caches, and so forth.

In one embodiment, the gaming system 200 includes a processor 202, a memory 204, and a communications interface 205. The memory 204 may further include game logic 206, wagering logic 208, and user preferences 210.

The processor 202 is circuitry or logic enabled to control execution of a set of instructions. The processor 202 may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor 202 may be a single chip or integrated with other computing or communications elements. The processor 202 may also represent dedicated logic for performing the distributed solitaire game.

The memory 204 is a hardware element, device, or recording media configured to store data for subsequent retrieval or access at a later time. The memory 204 may be static or dynamic memory. The memory 204 may include a hard disk, random access memory, cache, removable media drive, mass storage, or configuration suitable as storage for data, instructions, and information. In one embodiment, the memory 204 and processor 202 may be integrated. The memory may use any type of volatile or non-volatile storage techniques and mediums.

In one embodiment, the components for implementing the distributed solitaire game may be implemented entirely within hardware, software, firmware, or a combination thereof. In one example, the game logic 206 and the wagering logic 208 may be implemented in digital logic for implementation by the gaming system 200. For example, the game logic 206 and wagering logic 208 may be implemented in an ASIC, FPGA, or other type of fixed or programmable logic.

In another embodiment, the game logic 206, wagering logic 208, and user preferences 210 may be stored as a program, mobile app, script, or other set of instructions for execution by the processor 202. In one embodiment, the gaming system 200 may be a dedicated device, such as a wireless gaming console or casino gaming console for implementing the distributed solitaire game along with a number of other games.

The communications interface 205 is configured for communications with any number of wired or wireless networks. The communications interface 205 may also be configured for direct communications with other systems, devices, or equipment. For example, a group of friends may play the distributed solitaire game amongst themselves by direct or indirect communications through a wireless network or wireless communications, such as Wi-Fi, Bluetooth, WiMAX, infrared connection, or so forth. Similarly, any number of direct communications between devices may be utilized.

The game logic 206 provides the instructions, commands, data, and information for performing the distributed solitaire game. The game logic 206 may synchronize and coordinate the distribution of an electronic hand/deck for a number of users to play against one another. As a result, no one user has any advantage over the other users. By distribution the same hand to all the players, the players may be assured that the individual with the best skills may win, rather than some sort of undue influence, fraud, or other factors contributing to one or more players improperly winning.

The game logic 206 may link multiple users that decide to participate in a single distributed solitaire game. The cards as electronically dealt may be distributed between the users for simultaneous play. For example, the game logic 206 may coordinate game play for a first user utilizing a television and integrated browser, a second user utilizing a mobile app, a third user utilizing a laptop, and a fourth user utilizing a tablet computer.

In one embodiment, the game logic 206 may not have a pre-established time period for completion of the game allowing users of varying skill levels to play. For real-time distributed solitaire games, the game logic 206 may establish a time-out period or time period during which the user must finish the game to participate in scoring the results. For example, the time period may have a high threshold, such as five minutes for playing through a single deck game of solitaire. The game logic 206 may also enable head to head participation between users.

In another embodiment, the game logic 206 may coordinate a series of games to determine the best user or player. For example, the competition may be a best of ten or one hundred game series in which the top scoring user wins the entire game series. Multiple games may be utilized to perform a tournament or more competitive play, similar to the world series of poker. In another embodiment, a single hand may be played at different times by multiple users allowing the users to compete against each other even if they are not available to play at the same time. For example, the card configuration or shuffling for ten one hand games may be distributed to a group of friends to play on their own time table to determine who will score the most total points for a particular type of solitaire.

The wagering logic 208 stores information regarding wagers on any of the distributed solitaire games or series of games played by the users. The game logic 206, wagering logic 208, and user preferences 210 may include or communicate with one or more databases for storing information received from one or more users. The wagering logic 208 may include account profiles for a number of users. For example, the account profile may include a user name, password, identifying information, forms of payment, such as bank accounts, credit cards, electronic payment resources and so forth, enabling the user to both play and wager on the distributed solitaire game. For example, the wagering logic 208 may withdraw a specified amount of money from the user's balance maintained by the wagering logic 208 in order to participate in a distributed solitaire game with the proceeds being thereafter distributed to the winning users.

In one embodiment, the wagering logic 208 may allow the users in a single or multi-player game to wager on the distributed game in any multiples of ten beginning with one cent through thousands of dollars. In one embodiment, a tenth of the wager (Wager/10) may be earned for each card that is moved into a scoring position. This same system may apply to any single digit number and every multiple of ten. The wagering logic 208 may automatically establish groups of users playing against one another based on their specified levels of wagers or bets on a particular game. For example, users at skill level four (assuming a 1-10 skill level with 1 being novice and 10 being expert) may be grouped together during games. Users may also be grouped based on self-selection, geographic area, organization, group identification, distributed link, or so forth.

In another embodiment, the payout may be calculated by the wagering logic 208, such that the payout based on the results is proportional to the amount wagered by the user on the game to maintain equity between users that wager large amounts and small amounts.

The wagering logic 208 may also coordinate and manage games that are played for points or rankings. For example, applicable federal, country, state, region, or local regulations may specify whether the game may be played for money and the applicable rules.

In one embodiment, the user preferences 210 set parameters, settings, and configurations for playing the distributed solitaire game. For example, the user may specify card color, background, avatar, decorations, and configuration for display during the distributed solitaire game. The user preferences 210 may also store selections the user has made regarding preferred skill status, minimum wager amounts, and wagering limitations that may be automatically implemented by the gaming system 200. The user preferences 210 may also store preferences for displaying information and results to the user or otherwise communicating such information in real time or by discreet messages. Functionality of various websites, social networks, or so forth may be integrated with the features of distributed solitaire gaming to allow for communications, such as Internet calling, text, video, or instant messaging, sharing status, and so forth.

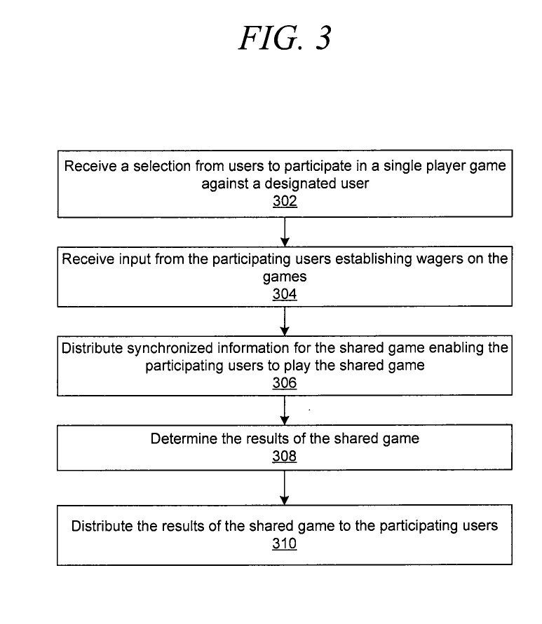

FIG. 3 is a flowchart of a process for distributed solitaire gaming in accordance with an illustrative embodiment. The process of FIG. 3 may be implemented by a gaming system, device, or network based implementation. The process of FIG. 3 may be implemented in response to user selections or input received through a peripheral, touch screen, mouse and keyboard, voice commands, visual actuation system, tactile input, or other input means known in the art.

The process may begin by receiving a selection from users to participate in a distributed solitaire game against a designated user and then (step 302). In one embodiment, the user may select a button or icon labeled “begin new game” or may enter a session already in process to participate in the game. The designated user may be a professional, highly experienced, or other user against which the other users are pitting themselves to ascertain or judge their skills. In one embodiment, the distributed solitaire game is being synchronized or displayed by a pre-established television channel or digital stream. Versions of the distributed solitaire game may also have a charitable component. For example, where play is synchronized by streaming media, such as a television or Internet show, a portion of the proceeds (e.g. two cards purchased/unpurchased in the fifty card deck) may be donated to a charity of the user's choice. In another embodiment, users are automatically grouped together to form a game in response to reaching a minimum number of players ready to play or participate. As previously described, user may be grouped together based on any number of criteria.

Next, the system receives input from the participating users establishing wagers on the distributed solitaire game (step 304). If selected, the user may establish an amount to wager per game or so forth. The users may also be enabled to play strictly for points or for free. Next, the system distributes synchronized information for the distributed solitaire game, enabling the participating users to play the distributed solitaire game (step 306). The information distributed during step 306 may be communicated across multiple computing and communications platforms, systems, equipment, and devices. During step 306, the users may actually play the distributed solitaire game to its conclusion. The game play and each move for each of the multiple users may be stored for later recreation or playback by one or more of the users.

Next, the system determines the results of the distributed solitaire game (step 308). In one embodiment, the users participating in a particular game may be ranked according to the scoring results. For example, the system may determine the winners and losers on the distributed solitaire game. The results may also include any money, points, credits, or so forth gained by each of the users from playing or winning the distributed solitaire game.

Next, the system distributes the results of the distributed solitaire game to the participating users (step 310). The results may be distributed through a program, graphical user interface, email message, text message, or real time display according to the user preferences set by the user. The results may include not only who won and lost, but any wagers, points, or other recognition associated with the distributed solitaire game.

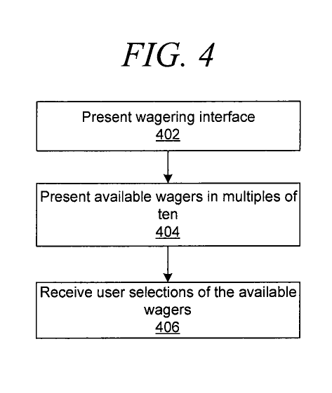

FIG. 4 is a flowchart of a process for wagering on distributed solitaire gaming in accordance with an illustrative embodiment. The process of FIG. 4 may begin with the system presenting a wager interface to a user (step 402). The wagering interface may include any number of preconfigured selection amounts, blank fields, or so forth for wagering on one or more distributed solitaire games.

In one embodiment, the wagering interface may be presented to the user before beginning the distributed solitaire game to establish expectations. As previously noted, the system may present available wagers in multiples of ten (step 404). The user may select from the available wagers or may input manual amounts.

Next, the system receives user selections of the available wagers (step 406). The user selections and input received in FIGS. 3 and 4 may be received through icons, buttons, text input (i.e. directly or through a peripheral or interface), voice input, tactile input, gesture commands, or so forth.

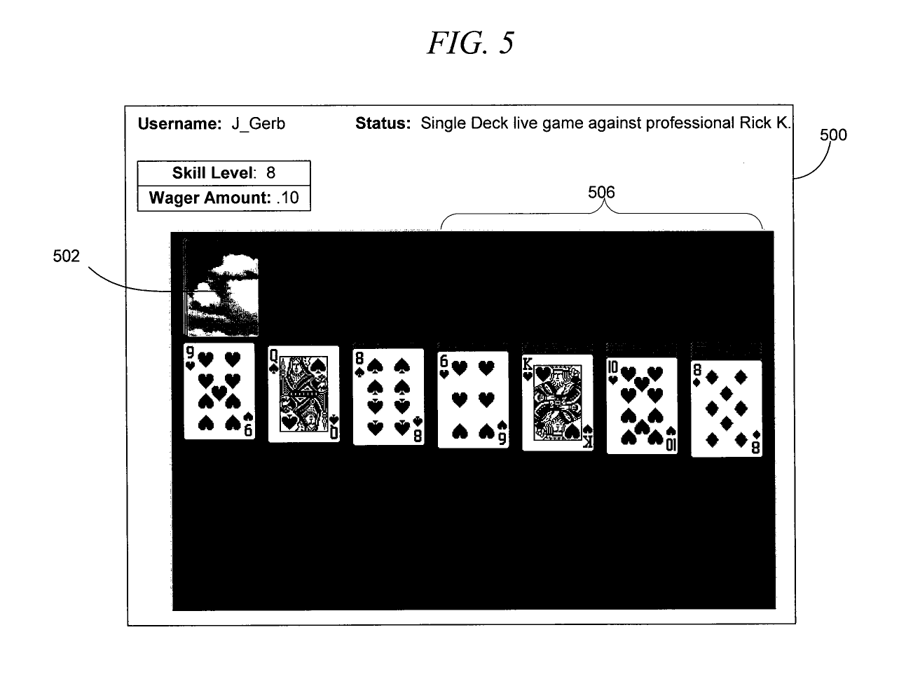

FIG. 5 is a pictorial representation of a user interface 500 for distributed solitaire gaming in accordance with an illustrative embodiment. The user interface 500 may display various information, data, and graphics to the user. For example, the user interface 500 may display a username associated with the user participating in the game. The user interface 500 may also display usernames, avatars, statistics or other information for the other users playing in the distributed solitaire game.

In one embodiment, the status may indicate what type of game the user is participating in. For example, the user interface 500 may indicate that the user is currently playing against a professional player. The user interface 500 may specifically call out a skill level and wager amount associated with the distributed solitaire game and user. The user interface 500 may include icons, buttons, or other selection elements for increasing or decreasing the skill level or wager amount before, during, or after the game.

The user interface 500 may also be specially configured for utilization with a touchscreen device. For example, by selecting or dragging cards from one point to another a user may participate in the game. In one embodiment, the user plays with a deck 502, including cards 504 that the user attempts to move into a scoring position 506. The user scores points by moving the cards 504 into the scoring position 506 in accordance with the specified rules of the solitaire game.

A player may wager any single digit number and any corresponding multiple of ten.

In one embodiment, using a standard 52 card deck, the wager may only buy the player 50 cards. In this embodiment, the player does not pay to buy, or get paid for, two of the cards.

In a similar embodiment, the wager buys the player a full deck of cards and the payoff applies to every card that makes it to the scoring position.

The user interface 500 may be configured for various forms or types of solitaire and may be customizable based on user preferences. The user interface 500 may also be configured for head-to-head competitions, best of ten (e.g. playing against a professional, expert, or experienced user), best of one hundred, beat the best, and so forth.

In one embodiment, the user interface 500 may include ads that are displayed to generate revenue for the game operator or service provider. In another embodiment, the game operator may receive a small amount of money for all wagers placed on the game. The game operator may also act as the house in a traditional wagering system.

The illustrative embodiments provide a system, method, and devices for participating in a distributed solitaire game. The game may be adapted to new delivery systems and methods ensuring that more users are encouraged to play the game. The simplified wagering (e.g. multiples of ten and a fifty card deck) may help users to better understand the game, wagers, and results.

The previous detailed description is of a small number of embodiments for implementing the invention and is not intended to be limiting in scope. The following claims set forth a number of the embodiments of the invention disclosed with greater particularity.

What is claimed:

1. A method for distributed solitaire gaming, the method comprising:
receiving selections from a plurality of users to participate in a shared game of solitaire;
receiving wagering information for the shared game from the plurality of users;
synchronizing the shared game between the plurality of users for playing the shared game against one another; and
distributing results of the shared game to the plurality of users.

2. The method according to claim 1, wherein the plurality of users play a wager against the house or one another.

3. The method according to claim 1, wherein the wagering information is received prior to the shared game beginning, and wherein the results include distributing wagers in response to the wagering information received from the plurality of users.

4. The method according to claim 1, wherein the shared game is synchronized between a plurality of networks including at least a television network or a data network.

5. The method according to claim 1, further comprising:
displaying a user interface for receiving the selections, the wagering information, and synchronizing the shared game.

6. The method according to claim 2, wherein the plurality of users are allowed a single pass through a deck.

7. The method according to claim 2, wherein the plurality of users are allowed multiple passes through a deck.

8. The method according to claim 2, wherein the wagering information is received in single digit numbers and corresponding multiples of ten.

9. The method according to claim 1, wherein the wagering information is received in non-monetary terms.

10. The method according to claim 1, wherein one of the plurality of users that moves the most cards of a deck to a scoring position wins, and wherein two or more of the plurality of users that tie split a win.

11. A system for distributed solitaire gaming, the system comprising:
a server configured to receive selections from a plurality of users to participate in a shared game of solitaire, receive wagering information for the shared game from the plurality of users, synchronize the shared game between the plurality of users for playing the shared game against one another, and distribute results of the shared game to the plurality of users; and
a database in communication with the server, the database configured to store the selection, wagering information, and results.

12. The system according to claim 11, wherein the results include wagers on the shared game that are distributed according to points scored by each of the plurality of users.

13. The system according to claim 11, wherein the shared game is configured for single deck, multiple deck, head-to-head, and beat the best configurations.

14. The system according to claim 11, wherein each of the plurality of users communicate with the server utilizing a secured connection and a client device, and wherein the database stores a user profile for each of the plurality of users including an electronic wallet.

15. The system according to claim 11, wherein the wagering information is enabled to allow wagers in single digit numbers and corresponding multiples of ten.

16. A server comprising:
a processor for executing a set of instructions; and
a memory for storing the set of instructions, wherein the set of instructions are executed to:
receive selections from a plurality of users to participate in a shared game of solitaire;
receive wagering information for the shared game from the plurality of users;
synchronize the shared game between the plurality of users for playing the shared game against one another; and
distribute results of the shared game to the plurality of users.

17. The server according to claim 16, wherein the results include wagers on the shared game that are distributed according to points scored by each of the plurality of users.

18. The server according to claim 16, wherein the shared game is configured for single deck, multiple deck, head-to-head, and beat the best configurations.

19. The server according to claim 16, wherein each of the plurality of users communicate with the server utilizing a secured connection and a client device.

20. The server according to claim 16, wherein the wagering information is enabled to allow monetary and nonmonetary wagers.
